(19) United States
(12) Patent Application Publication
(10) Pub. No.: US 2020/0180121 A1
(43) Pub. Date: Jun. 11, 2020

(54) REVERSIBLE WRENCH

(71) Applicant: PO-YEN CHANG, Taichung City (TW)

(72) Inventor: PO-YEN CHANG, Taichung City (TW)

(21) Appl. No.: 16/215,957

(22) Filed: Dec. 11, 2018

(51) Int. Cl. B25B 13/46

(52) U.S. Cl. CPC B25B 13/462; B25B 13/468

(57) ABSTRACT

A reversible wrench is provided, including: a main body, including a head and a through hole penetrating through the head; a driving member, being rotatably disposed within the through hole and including an abutting portion which is non-circular and disposed within the through hole; a switch member, including a base portion and a plurality of projections protruding from the base portion, each of the plurality of rolling members being movable between adjacent two ones of the plurality of projections and abuttable against the abutting portion and an inner wall of the through hole; a plurality of magnetic members, being disposed on the driving member and the switch member with the same magnetic polarity facing toward each other, magnetically attractive to at least one of the driving member and the switch member so that the driving member and the switch member are configured to be rotatable together.

### BACKGROUND OF THE INVENTION

### Field of the Invention

The present invention relates to a reversible wrench.

### Description of the Prior Art

A conventional reversible wrench is a ratchet wrench which are driven by ratcheting engagement or a ratchetless wrench which are driven by frictional engagement of a plurality of rollers. However, the conventional reversible wrench usually requires a restricting member, such as a roller and a spring, to restrict a rotation direction of the reversible wrench, which requires accurate coordination of structures and is inconvenient to manufacture.

The present invention is, therefore, arisen to obviate or at least mitigate the above-mentioned disadvantages.

### SUMMARY OF THE INVENTION

The main object of the present invention is to provide a reversible wrench which has a switch mechanism using magnetic force and has a simple structure.

To achieve the above and other objects, the present invention provides a reversible wrench, including: a main body, a driving member, a switch member, a plurality of rolling members and a plurality of magnetic members. The main body includes a head and a through hole penetrating through the head. The driving member is rotatably disposed within the through hole and includes an abutting portion which is non-circular and disposed within the through hole. The switch member includes a base portion and a plurality of projections protruding from the base portion. The plurality of projections are disposed around the abutting portion. The switch member is rotatably switchable relative to the driving member between a first position in which the driving member is unidirectionally rotatable in a first rotation direction and a second position in which the driving member is unidirectionally rotatable in a second rotation direction reversed to the first rotation direction. The plurality of rolling members are disposed around the abutting portion. Each of the plurality of rolling members is movable between adjacent two ones of the plurality of projections and abuttable against the abutting portion and an inner wall of the through hole. The plurality of magnetic members are disposed on the driving member and the switch member with the same magnetic polarity facing toward each other, magnetically attractive to at least one of the driving member and the switch member so that the driving member and the switch member are configured to be rotatable together.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 2A is a partial breakdown drawing of FIG. 2;

FIG. 3 is a cross-sectional view taken along line A-A of FIG. 1;

FIG. 4 is a cross-sectional view taken along line B-B of FIG. 1;

FIGS. 5 and 6 are operational schematic diagrams of a preferable embodiment of the present invention.

### DETAILED DESCRIPTION OF THE PREFERRED EMBODIMENTS

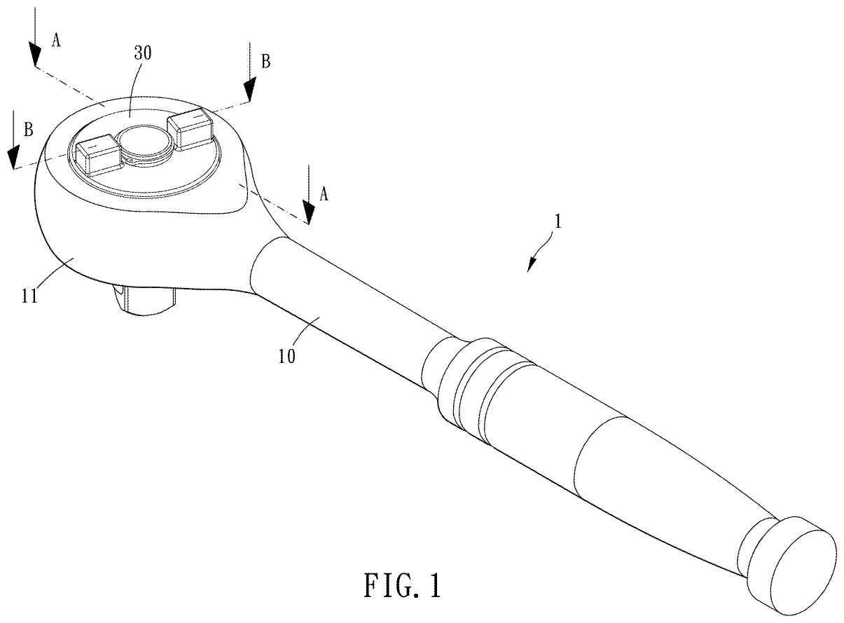

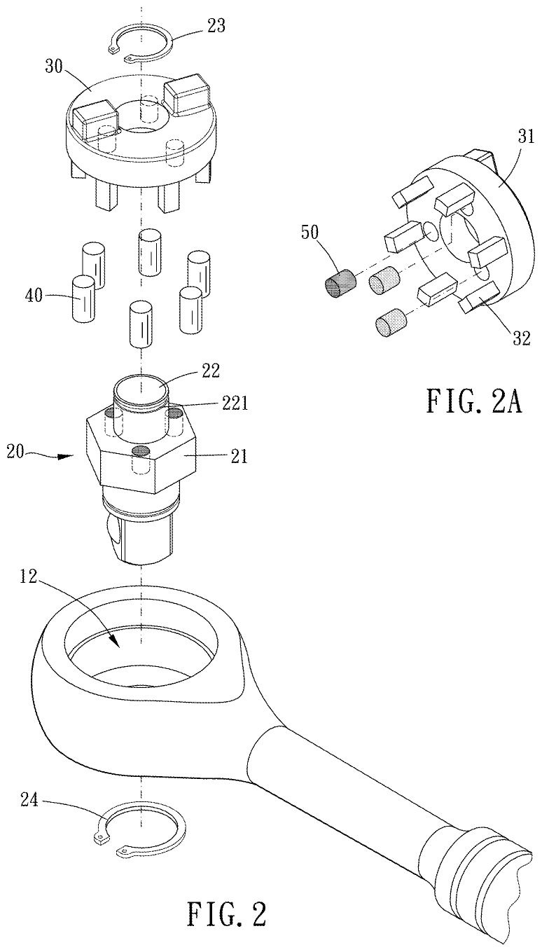

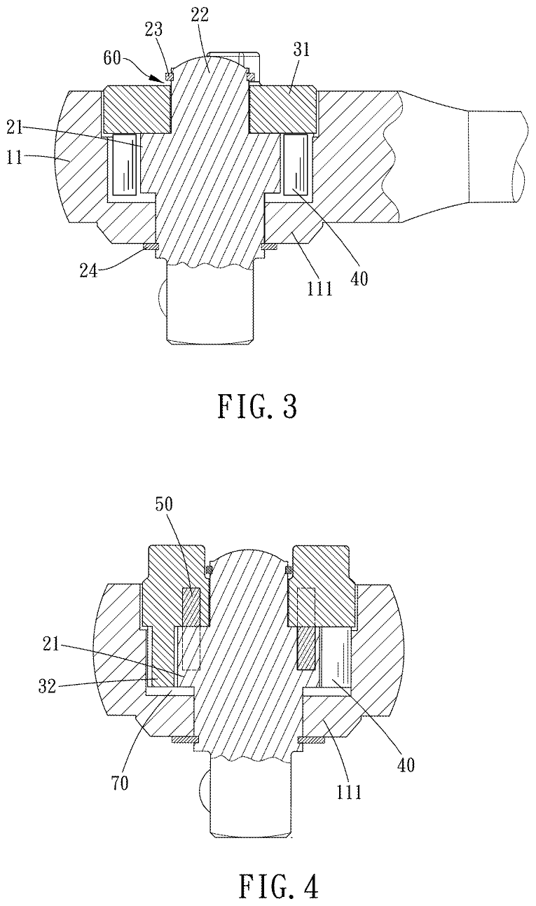

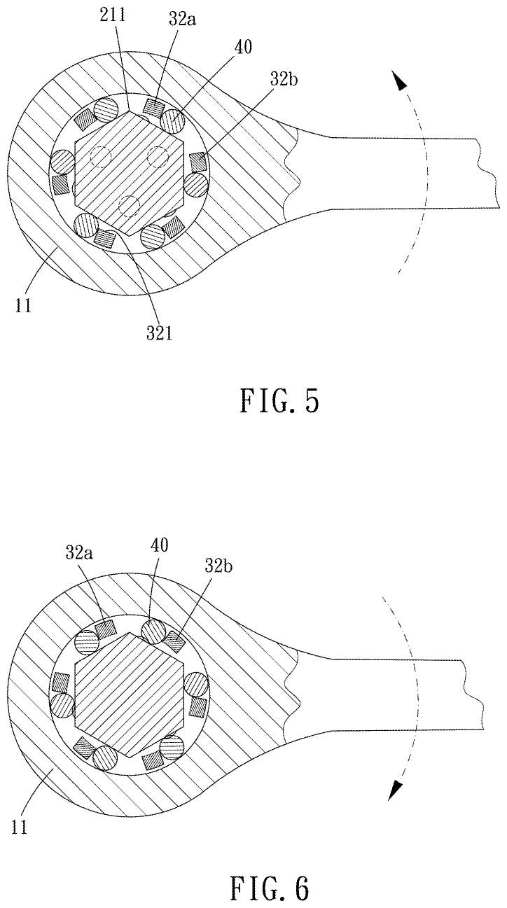

Please refer to FIGS. 1 to 6 for a preferable embodiment of the present invention. A reversible wrench 1 of the present invention includes a main body 10, a driving member 20, a switch member 30, a plurality of rolling members 40 and a plurality of magnetic members 50.

The main body 10 includes a head 11 and a through hole 12 penetrating through the head 11. The driving member 20 is rotatably disposed within the through hole 12 and includes an abutting portion 21 which is non-circular and disposed within the through hole 12. The switch member 30 includes a base portion 31 and a plurality of projections 32 protruding from the base portion 31. The plurality of projections 32 are disposed around the abutting portion 21. The switch member 30 is rotatably switchable relative to the driving member 20 between a first position in which the driving member 20 is unidirectionally rotatable in a first rotation direction and a second position in which the driving member 20 is unidirectionally rotatable in a second rotation direction reversed to the first rotation direction. The plurality of rolling members 40 are disposed around the abutting portion 21. Each of the plurality of rolling members 40 is movable between adjacent two ones of the plurality of projections 32 and abuttable against the abutting portion 21 and an inner wall of the through hole 12. The plurality of magnetic members 50 are disposed on the driving member 20 and the switch member 30 with the same magnetic polarity facing toward each other, magnetically attractive to at least one of the driving member 20 and the switch member 30 so that the driving member 20 and the switch member 30 are configured to be rotatable together. Therefore, the switch member 30 can be constrained, by magnetic force, in one of opposite rotation directions in which the driving member 20 rotates, and the reversible wrench 1 has a simple structure.

Any adjacent two of the plurality of projections 32a, 32b are arranged with one of the rolling members 40 located therebetween, and at least one of the rolling members 40 is, in the first rotation direction, abuttable against one of adjacent two of the plurality of projections 32a and, in the second rotation direction, abuttable against the other of the adjacent two of the plurality of projections 32b so that one of the rolling members 40 can be nonslidably abutted against one of the adjacent two of the plurality of projections 32a, 32b. The driving member 20 is jammed in one of the first rotation direction and the second rotation direction by at least one of the plurality of rolling members 40. Therefore, the driving member 20 can be configured to drive a socket, tool bit or the like. Preferably, the base portion 31 and the plurality of projections 32 are integrally formed in one piece so as to increase structural integrity.

A maximum distance between each of the plurality of projections 32 and one of the plurality of rolling members 40 adjacent thereto is larger than a diametric dimension of each of the plurality of magnetic members 50 so that the switch member 30 can be switchable between the first position and the second position and connected with the driving member 20 without influence of repulsive force of the plurality of magnetic members 50. Preferably, respective numbers of the magnetic members 50 disposed on the driving member 20 and the switch member 30 are odd so that the switch member 30 is easy to be rotated relative to the driving member 20 in switching.

The abutting portion 21 includes at least one convex portion 211 laterally protruding therefrom. When the switch member 30 is switched between the first position and the second position, at least one of the plurality of projections 32 passes over one of the at least one convex portion 211 and is abuttable against one of the rolling members 40 to restrict the driving member 20. Each of the plurality of rolling members 40 has a diametric dimension larger than that of each of the plurality of projections 32 so that the abutting portion 21 can pass over the plurality of projections 32 and be radially abutted against at least one of the rolling members 40. In this embodiment, each of the plurality of projections 32 includes a concave 321 facing toward the abutting portion 21, which allows the plurality of projections 32 to rotate without interference or obstacle.

In this embodiment, the abutting portion 21 is a polygon, and numbers of the plurality of projections 32 and the plurality of rolling members 40 are respectively equal to a number of sides of the polygon. When the switch member 30 is switched between the first position and the second position, at least one of the plurality of projections 32 passes over one of corners of the polygon. However, the abutting portion may be provided with another shape such as oval or irregular shape according to various requirements.

The driving member 20 further includes a connecting portion 22 extending axially, and the connecting portion 22 has a receiving groove 221 which is engageable with a retainer 23. The connecting portion 22 is disposed through and beyond the base portion 31, and the base portion 31 is restricted between the retainer 23 and the abutting portion 21. Therefore, the driving member 20 is easy to be assembled with the switch member 30 without additional processing such as screwing or mounting. Preferably, a gap 60 is defined between the retainer 23 and the base portion 31 in an axial direction so that the switch member 30 can shift relative to the driving member 20 in the axial direction for easy turning when it is switched between the first position and the second position.

The head 11 includes a flange 111 which is disposed around the inner wall of the through hole 12, and the flange 111 is abuttable against at least one of the switch member 30 and the driving member 20. In this embodiment, the driving member 20 further has a retainer 24 disposed thereon, and the flange 111 is located between the abutting portion 21 and the retainer 24 so that the driving member 20 and the switch member 30 can be restricted within the through hole 12. A gap 70 is defined between the flange 111 and the abutting portion 21 in the axial direction so that the driving member 20 is movable toward the flange 111 and can shift relative to the switch member 30 in the axial direction so that the switch member 30 is easy turning when it is switched between the first position and the second position.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A reversible wrench, including:
a main body, including a head and a through hole penetrating through the head;
a driving member, rotatably disposed within the through hole, including an abutting portion which is non-circular and disposed within the through hole;
a switch member, including a base portion and a plurality of projections protruding from the base portion, the plurality of projections being disposed around the abutting portion, the switch member being rotatably switchable relative to the driving member between a first position in which the driving member is unidirectionally rotatable in a first rotation direction and a second position in which the driving member is unidirectionally rotatable in a second rotation direction reversed to the first rotation direction;
a plurality of rolling members, being disposed around the abutting portion, each of the plurality of rolling members being movable between adjacent two ones of the plurality of projections and abuttable against the abutting portion and an inner wall of the through hole;
a plurality of magnetic members, disposed on the driving member and the switch member with the same magnetic polarity facing toward each other, magnetically attractive to at least one of the driving member and the switch member so that the driving member and the switch member are configured to be rotatable together.

2. The reversible wrench of claim 1, wherein any adjacent two of the plurality of projections are arranged with one of the rolling member located therebetween, at least one of the rolling members is, in the first rotation direction, abuttable against one of adjacent two of the plurality of projections and, in the second rotation direction, abuttable against the other of the adjacent two of the plurality of projections.

3. The reversible wrench of claim 1, wherein a maximum distance between each of the plurality of projections and one of the plurality of rolling members adjacent thereto is larger than a diametric dimension of each of the plurality of magnetic members.

4. The reversible wrench of claim 1, wherein respective numbers of the magnetic members disposed on the driving member and the switch member are odd.

5. The reversible wrench of claim 1, wherein the abutting portion includes at least one convex portion laterally protruding therefrom, and when the switch member is switched between the first position and the second position, at least one of the plurality of projections passes over one of the at least one convex portion.

6. The reversible wrench of claim 1, wherein each of the plurality of rolling members has a diametric dimension larger than that of each of the plurality of projections.

7. The reversible wrench of claim 1, wherein the abutting portion is a polygon, numbers of the plurality of projections and the plurality of rolling members are respectively equal to a number of sides of the polygon, and when the switch member is switched between the first position and the second position, at least one of the plurality of projections passes over one of corners of the polygon.

8. The reversible wrench of claim 1, wherein the driving member further includes a connecting portion extending axially, the connecting portion has a receiving groove which is engageable with a retainer, the connecting portion is disposed through and beyond the base portion, and the base portion is restricted between the retainer and the abutting portion.

9. The reversible wrench of claim 8, wherein a gap is defined between the retainer and the base portion in an axial direction.

10. The reversible wrench of claim 1, wherein the head includes a flange which is disposed around the inner wall of the through hole, and the flange is abuttable against at least one of the switch member and the driving member.

11. The reversible wrench of claim 10, wherein a gap is defined between the flange and the abutting portion in an axial direction.

12. The reversible wrench of claim 1, wherein the driving member is jammed in one of the first rotation direction and the second rotation direction by at least one of the plurality of rolling member.

13. The reversible wrench of claim 9, wherein any adjacent two of the plurality of projections are arranged with one of the rolling member located therebetween, at least one of the rolling members is, in the first rotation direction, abuttable against one of adjacent two of the plurality of projections and, in the second rotation direction, abuttable against the other of the adjacent two of the plurality of projections; a maximum distance between each of the plurality of projections and one of the plurality of rolling members adjacent thereto is larger than a diametric dimension of each of the plurality of magnetic members; respective numbers of the magnetic members disposed on the driving member and the switch member are odd; the abutting portion includes at least one convex portion laterally protruding therefrom, and when the switch member is switched between the first position and the second position, at least one of the plurality of projections passes over one of the at least one convex portion; each of the plurality of rolling members has a diametric dimension larger than that of each of the plurality of projections; the abutting portion is a polygon, numbers of the plurality of projections and the plurality of rolling members are respectively equal to a number of sides of the polygon, and when the switch member is switched between the first position and the second position, at least one of the plurality of projections passes over one of corners of the polygon; the head includes a flange which is disposed around the inner wall of the through hole, and the flange is abuttable against at least one of the switch member and the driving member; a gap is defined between the flange and the abutting portion in an axial direction; the driving member is jammed in one of the first rotation direction and the second rotation direction by at least one of the plurality of rolling member; the base portion and the plurality of projections are integrally formed in one piece; each of the plurality of projections includes a concave facing toward the abutting portion; the driving member further has a retainer disposed thereon, and the flange is located between the abutting portion and the retainer.
